(19) United States
(12) Patent Application Publication
(10) Pub. No.: US 2012/0124341 A1
(43) Pub. Date: May 17, 2012

(54) Methods and Apparatus for Performing Multiple Operand Logical Operations in a Single Instruction

(76) Inventor: Allen B. Goodrich, Reut (IL)

(21) Appl. No.: 12/947,971

(22) Filed: Nov. 17, 2010

(51) Int. Cl. G06F 9/30

(52) U.S. Cl. 712/220; 712/E09.016

(57) ABSTRACT

A method for performing multiple-operand logical operations in a single instruction includes the steps of: generating a table defining a correspondence between a plurality of input variables to a multiple-operand logical operation and a plurality of output results of the multiple-operand logical operation; encoding the table to generate a set of values for use by the single instruction, each value being indicative of an output result of the multiple-operand logical operation as a function of a corresponding unique combination of values of the input variables; and at least one processor performing the multiple-operand logical operation in a single instruction as a function of the set of values for a prescribed combination of values of the input variables.

### FIELD OF THE INVENTION

The present invention relates generally to the electrical, electronic, and computer arts, and more particularly relates to techniques for logical computations.

### BACKGROUND OF THE INVENTION

During processing, computer programs direct one or more hardware processors to perform various tests in making computational decisions. Most times, these tests are a series of arithmetic calculations and/or comparisons, such as, for example, “is A greater than B,” resulting in a logical true or false output which may be used for further processing. In some cases, there are multiple tests with multiple logical output results and the combination is generally difficult to process.

Having multiple logical values computed previously or currently, a single answer (e.g., “true” or “false”) can be computed in a conventional manner by performing a series of logical tests. However, performing a series of tests with intervening change of flow operations often results in longer execution times and increased instruction space and is thus undesirable.

### SUMMARY OF THE INVENTION

Principles of the invention, in illustrative embodiments thereof, advantageously enable multiple-operand logical calculations to be performed by at least one hardware processor in a single instruction step. According to an embodiment of the invention, for computer instructions, a table approach is preferably used to define any logical function of a number of input variables. Having this table encoded in any of (i) the instruction itself, (ii) an immediate field of the instruction, or (iii) in a register of the computer or other hardware (so that the test takes less time), a single operation performs any logical function on the input variables beneficially resulting in reduced cycles for control code execution and simplicity of assembled code, compiler design and compiled code.

In accordance with one embodiment of the invention, a method for performing multiple-operand logical operations in a single instruction includes the steps of: generating a table defining a correspondence between a plurality of input variables to a multiple-operand logical operation and a plurality of output results of the multiple-operand logical operation; encoding the table to generate a set of values for use by the single instruction, each value being indicative of an output result of the multiple-operand logical operation as a function of a corresponding unique combination of values of the input variables; and at least one processor performing the multiple-operand logical operation in a single instruction as a function of the set of values for a prescribed combination of values of the input variables.

In accordance with another embodiment of the invention, apparatus for performing multiple-operand logical operations in a single instruction includes memory and at least one processor coupled to the memory. The processor is operative: (i) to receive a table defining a correspondence between a plurality of input variables to a multiple-operand logical operation and a plurality of output results of the multiple-operand logical operation, the table being encoded so as to generate a set of values for use by the single instruction, each value in the set of values being indicative of an output result of the multiple-operand logical operation as a function of a corresponding unique combination of values of the plurality of input variables to the multiple-operand logical operation; and (ii) to perform the multiple-operand logical operation in a single instruction as a function of the set of values for a prescribed combination of values of the plurality of input variables.

These and other features, objects and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals indicate corresponding elements throughout the several views, and wherein:

FIG. 1 is an exemplary table illustrating bit assignments for a four-variable logical operation, according to an embodiment of the invention;

FIG. 2 is an exemplary table including entered logical values corresponding to a first illustrative logical operation, according to an embodiment of the invention;

FIGS. 3A through 3E illustrate an exemplary table including entered logical values corresponding to a second illustrative logical operation, according to an embodiment of the invention;

FIGS. 4A through 4C illustrate an exemplary table including entered logical values corresponding to a third illustrative logical operation, according to an embodiment of the invention;

FIG. 5 is a block diagram depicting at least a portion of an exemplary multiplexer operative to perform methodologies of the present invention, according to an embodiment of the invention;

FIG. 6 is a block diagram depicting at least a portion of an exemplary processor configured to implement methodologies of the present invention, according to an embodiment of the invention; and

FIG. 7 is a block diagram depicting an exemplary system in which methodologies of the present invention can be implemented, according to an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present invention will be described herein in the context of illustrative embodiments of a table-based methodology, and corresponding system for implementing such a methodology, for performing multiple-operand logical computations in a single instruction. It is to be appreciated, however, that the invention is not limited to the specific methods and apparatus illustratively shown and described herein. Rather, aspects of the invention are directed broadly to techniques for beneficially performing multiple-operand logical operations using a single instruction. In this manner, aspects of the invention provide a methodology which advantageously reduces instruction execution time and required instruction space for processor instructions.

While illustrative embodiments of the invention will be described herein with reference to specific logical operations (e.g., equations), it is to be appreciated that the invention is not limited to use with these particular logical operations. Rather, principles of the invention may be extended to essentially any logical operations involving multiple operands and corresponding results. Moreover, it will become apparent to those skilled in the art given the teachings herein that numerous modifications can be made to the embodiments shown that are within the scope of the present invention. That is, no limitations with respect to the specific embodiments described herein are intended or should be inferred.

For computer instructions, a table approach is preferably used to define any logical function of a number of input variables. Having this table encoded in any one or more of the instruction itself, an immediate field of the instruction, a register of the computer, or any other data source, to thereby reduce the execution time of a given multiple-operand instruction, a single operation is able to perform essentially any logical function on the input variables, thereby advantageously resulting in a reduced number of cycles for control code execution and simplicity of assembled code, compiler design and compiled code. Thus, aspects of the invention essentially combine any number of logical “results” into a single test.

By way of illustration only and without loss of generality, FIG. 1 depicts an exemplary logical table 100 defining a correspondence between a plurality of input variables to a multiple-operand logical operation and a plurality of output results of the multiple-operand logical operation. In the embodiment shown, table 100 includes four input variables, A, B, C and D, although the invention is not limited to any specific number of input variables. As apparent from the figure, there is one bit assigned to each of the possible combinations of the four input variables in table 100.

In this illustrative scenario, it is assumed that the four input variables (A through D) are binary variables (e.g., logic “0” and “1”), and thus there will be sixteen possible combinations (the number of combinations being equal to 2ⁿ, where n is the number of binary variables employed). For example, bit 0 is assigned to the combination Ā B̅ C̅ D̅, bit 1 is assigned to A B̅ C̅ D̅, bit 2 is assigned to ĀB C̅ D̅, bit 3 is assigned to AB C̅ D̅, bit 4 is assigned to Ā B̅C D̅, bit 5 is assigned to A B̅C D̅, bit 6 is assigned to ĀBC D̅, bit 7 is assigned to ABC D̅, bit 8 is assigned to Ā B̅ C̅D, bit 9 is assigned to A B̅ C̅D, bit 10 is assigned to ĀB C̅D, bit 11 is assigned to AB C̅D, bit 12 is assigned to Ā B̅CD, bit 13 is assigned to A B̅CD, bit 14 is assigned to ĀBCD, and bit 15 is assigned to ABCD. Using the representation above, for example, A and Ā are logical complements of one another (e.g., if A is “true”, Ā is “false,” and vice versa). The order of the labels and/or the assignment of the bits in table 100 can be changed as long as each of all possible combinations of input variables has an associated bit. This combination results in the number defined by {D,C,B,A} to address the bit number listed.

In accordance with other embodiments of the invention, each input variable may represent more than two possible values (i.e., states). In the general case where there are n input variables, with each input variable representing one of m possible logical values, the number of bit positions in the table will be equal to mⁿ, where m and n are integers greater than one.

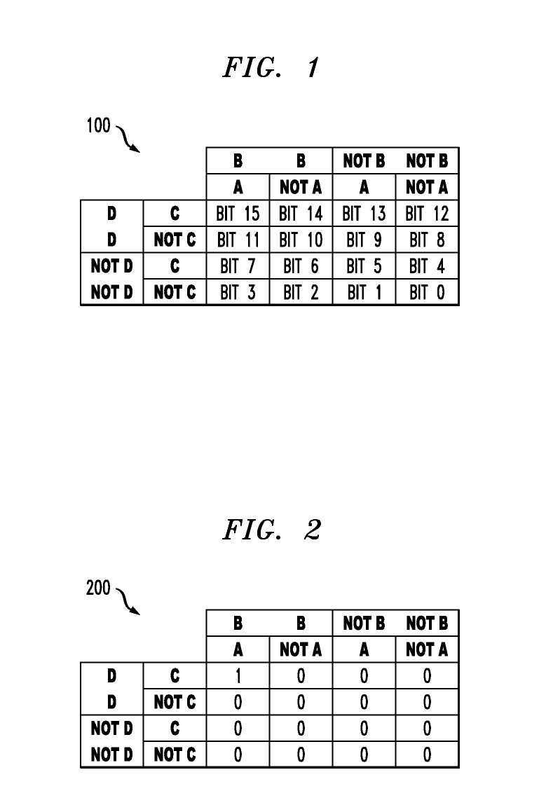

FIGS. 2 through 4 conceptually depict exemplary methodologies for determining multiple-operand logical calculations in a single operation, according to embodiments of the invention. In these examples, the following definitions are preferably employed:

TST=any existing test or logical or arithmetic operation having a logical result;

LTST=a simple name to represent any name for a new set of logical test instructions.

With reference now to FIG. 2, an exemplary table 200 is shown for facilitating multiple-operand calculations in a single instruction in conjunction with an illustrative logic equation (A and B and C and D), according to an embodiment of the invention. In table 200, the value 1000 0000 0000 0000 is placed in respective positions bit 15 through bit 0, with the most significant bit (left-most bit) being bit 15. Values may be entered into table 200 using a standard conversion methodology (preferably, table 200 is filled automatically, although manually entering values into the table is also contemplated) from the logic equation, wherein each bit in the table is indicative of an output result of the multiple-operand logical operation as a function of a unique combination of the four input variables to the multiple-operand logical operation.

A standard approach for determining this multiple-operand logical calculation result involves several steps. Specifically, for the illustrative equation (A and B and C and D), each of the four variables A, B, C and D must be tested using a logical comparison to determine whether the value is “true” (e.g., a logical “1”) or “false (e.g., a logical “0”). If any of the values are false (i.e., “0”), the test sequence generates a “fail” result. If all variables A, B, C, D, are determined to be “true” (i.e., none of variables are determined to be “false”), the test generates a “success” result. An illustrative methodology for determining this multiple-operand calculation is shown below in exemplary pseudo code:

Replacing Code:

TST into A
If False, fail
TST into B
If False, fail
TST into C
If False, fail
TST into D
If False, fail
Success:

In accordance with an embodiment of the invention, depending on the level of parallelism provided by the computational system (e.g., processor, general purpose computer, etc.) which is adapted to perform multiple-operand operations using techniques of the invention, the above multiple-step approach may be advantageously replaced with a single-instruction methodology, as shown below in pseudo code:

New Code:

TST into A, TST into B, TST into C, TST into D
LTST {D,C,B,A} on 16b1000_0000_0000_0000
If False, fail
Success:

The variables A, B, C, D can be, for example, flags or registers, although the invention is not limited to such constructions. For example, at least one of the input variables to the multiple-operand logical operation may comprise a status bit generated as a result of a previous or a current (i.e., parallel) operation performed by a processor implementing the method, according to an embodiment of the invention. In a practical implementation thereof, at least a portion of table 200 may be encoded in the instruction itself, encoded in an intermediate field of the instruction, and/or encoded in a register or other data storage structure of a computer or alternative processor operative to perform methodologies of the invention.

In order to reduce execution time, one or more values (i.e., bit positions) of at least one register, memory and/or logical operation can have prescribed and/or configurable definitions with regard to their respective logical values. By way of example only and without limitation, one or more bit positions in a register, memory and/or arithmetic or logical operation may have a value of all zeros (e.g., false) or all ones (e.g., true). Likewise, a sign bit (e.g., most significant bit (MSB)) of the contents of a register, memory and/or logical operation may be predefined to be a one or a zero, for example, to indicate a positive or negative number. Programs often employ a predefined logical value to indicate a “true” or “false” result of a logical operation.

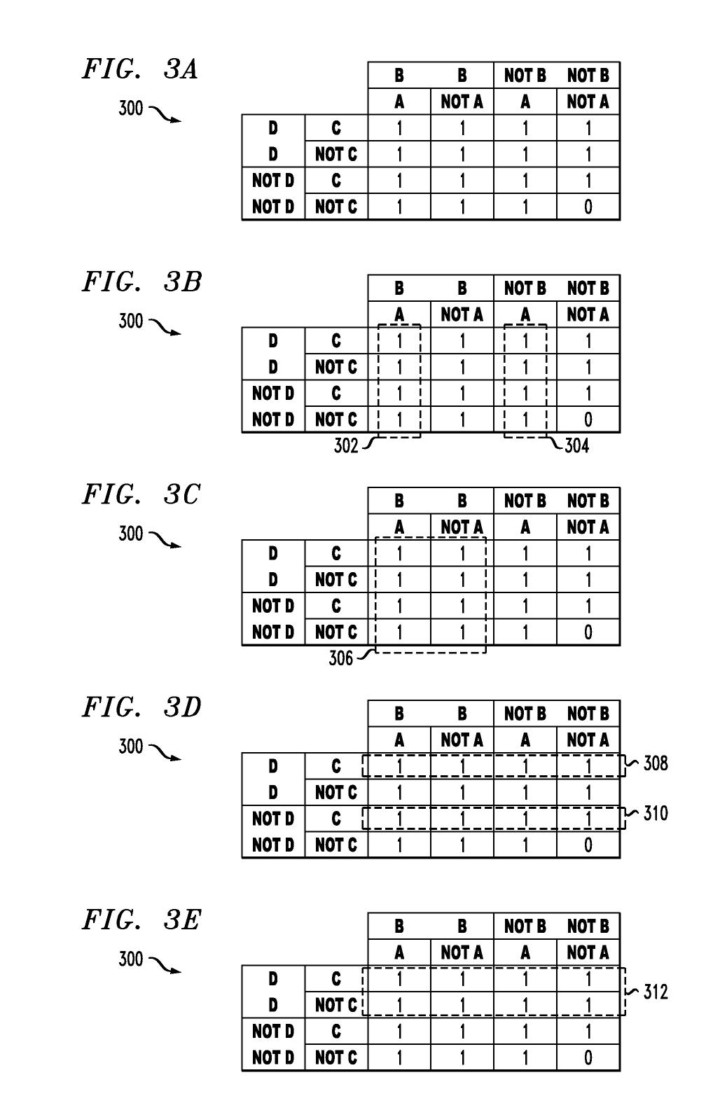

FIGS. 3A through 3E collectively depict an exemplary table 300 for performing multiple-operand calculations in a single instruction in conjunction with an illustrative logic equation (A or B or C or D), according to an embodiment of the invention. With reference to FIG. 3A, in table 300, the value 1111 1111 1111 1110 is placed into respective positions bit 15 through bit 0 (using the exemplary bit assignments shown in FIG. 1), with the most significant bit (left-most bit) being bit 15. As in the illustrative scenario described above, a logical “0” is arbitrarily assigned to indicate a “false” result and a logical “1” is indicative of a “true” result. To match the illustrative equation (A or B or C or D), FIG. 3B shows table entries, 302 and 304, for which variable A is true (e.g., logic “1”), FIG. 3C shows table entries, 306, for which variable B is true, FIG. 3D shows table entries, 308 and 310, for which variable C is true, and FIG. 3E shows table entries, 312, for which variable D is true.

A standard approach for determining this multiple-operand logical calculation involves several steps. Specifically, as for the multiple-operand equation illustrated in connection with FIG. 2, each of the four variables A, B, C and D in the equation (A or B or C or D) must be tested using a logical comparison to determine whether the value is “true” or “false.” If any of the variables is true (i.e., “1”), the test sequence generates a “success” result. If a given one of the variables A, B, C, D is determined to be “false,” the test sequences to the next variable until a “true” is detected. If all variables A, B, C, D are determined to be “false,” the test generates a “fail” result. An illustrative methodology for determining this multiple-operand calculation is shown below in exemplary pseudo code:

Replacing Code:

TST into A
If True, Success
TST into B
If True, Success
TST into C
If True, Success
TST into D
If True, Success
Fail:

In accordance with an embodiment of the invention, depending on the level of parallelism provided by the computational system (e.g., processor, general purpose computer, etc.) which is adapted to perform multiple-operand calculations using techniques of the invention, the above multiple-step approach may be advantageously replaced with a single-instruction methodology, as shown below in pseudo code:

New Code:

TST into A, TST into B, TST into C, TST into D
LTST {D,C,B,A} on 16b1111_1111_1111_1110
If False, fail
Success:

The variables A, B, C, D can be, for example, flags or registers, although the invention is not limited to such constructions. In a practical implementation thereof, at least a portion of table 200 may be encoded in the instruction itself, encoded in an immediate field of the instruction, and/or encoded in a register or other storage structure of a computer or alternative processor operative to perform methodologies of the invention.

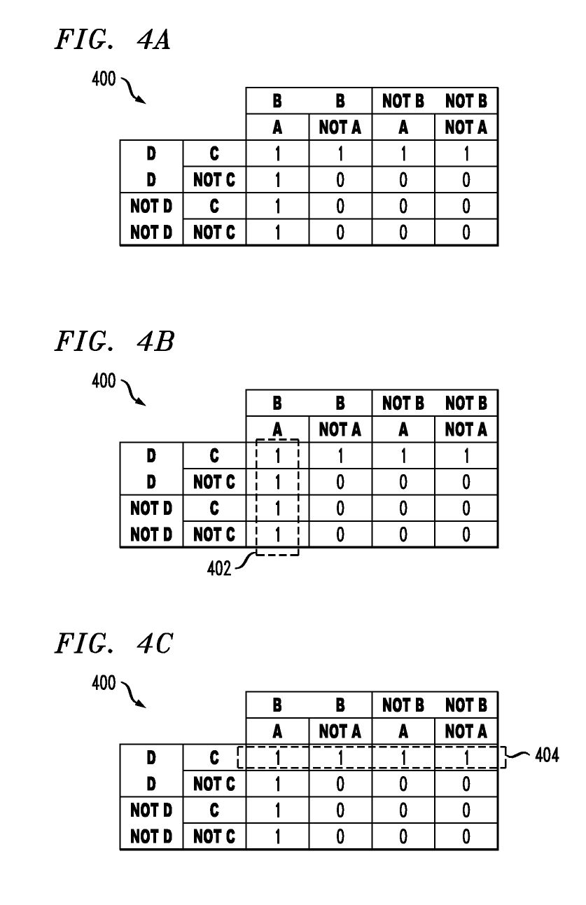

FIGS. 4A through 4C collectively depict an exemplary table 400 for performing multiple-operand calculations in a single instruction in conjunction with an illustrative logic equation ((A and B) or (C and D)), according to an embodiment of the invention. In table 400, the value 1111 1000 1000 1000 is placed in respective positions bit 15 through bit 0 (using the exemplary bit assignments shown in FIG. 1), with the most significant bit (left-most bit) being bit 15. To match the illustrative equation ((A and B) or (C and D)), FIG. 4B shows table entries, 402, for which both variables A and B are true (e.g., logic “1”), and FIG. 4C shows table entries, 404, for which both variables C and D are true.

A standard approach for determining this multiple-operand logical calculation involves several steps. Specifically, as for the multiple-operand equations illustrated in connection with FIGS. 2 and 3, each of the four variables A, B, C and D in the equation ((A and B) or (C and D)) must be tested using a logical comparison to determine whether the variable is “true” or “false.” Because this equation involves comparing two separate quantities, each quantity (e.g., (A and B) and (C and D)) first requiring the determination of a multiple-operand calculation, the process of determining a result involves calls to a nested structure (e.g., subroutine), which involves additional steps and computational time.

More particularly, in order to determine a result to the equation ((A and B) or (C and D)), the methodology checks variable A to determine if it is false (e.g., logic “0”). If false, the result of the quantity (C and D) must be determined (i.e., TST2 below). Variable C is tested and if determined to be “false,” a “fail” is generated by the test. Otherwise, when variable C is determined to be “true,” variable D is tested and if determined to be “false,” the test sequence returns a “fail” result. If both variables C and D are “true,” the test generates a “success,” result. If either variable C or D is “false,” the test generates a “fail” result. If variable A is determined to be “true,” variable B is tested and, if determined to be “false,” the quantity (C and D) is evaluated as in the case where variable A is determined to be “false.” Otherwise, if quantity (A and B) is determined to be “true,” the test generates a “success” result. An illustrative methodology for determining this multiple-operand calculation is shown below in exemplary pseudo code:

Replacing Code:

TST into A
If False, TST2
TST into B
If False, TST2
GOTO Success
TST2:
TST into C
If False, Fail
TST into D
If False, Fail
Success:

In accordance with an embodiment of the invention, depending on the level of parallelism provided by the computational system (e.g., processor, general purpose computer, etc.) which is adapted to perform multiple-operand calculations using techniques of the invention, the above multiple-step approach may be advantageously replaced with a single-instruction methodology, as shown below in pseudo code:

New Code:

TST into A, TST into B, TST into C, TST into D
LTST {D,C,B,A} on 16b1111_1000_1000_1000
If False, fail
Success:

The variables A, B, C, D can be, for example, flags or registers, although the invention is not limited to such constructions. In a practical implementation thereof, at least a portion of table 200 may be encoded in the instruction itself, encoded in an immediate field of the instruction, and/or encoded in a register or other storage structure of a computer or alternative processor operative to perform methodologies of the invention.

As noted from the illustrative cases shown and described above, the “Replacing Code” is different for each whereas the “New Code” only differs by the table value. Using table-based methods in this manner, complex logical operations can be implemented in a single instruction step, thereby achieving significant advantages in computational speed and processing overhead compared to conventional approaches.

It is to be appreciated that, although four variables (A, B, C, D) were used in the exemplary calculations, the invention is not limited to any specific number of values, and that a lesser number of operands (e.g., 3 or less) or a greater number of operands (e.g., 5 or more) may be employed. One skilled in the art, given the teachings herein, will be able to extend the techniques of the invention to a table including 2″ bit positions for implementing a logic function having n variables, where n is a positive integer.

Moreover, although specific logic equations were used in conjunction with FIGS. 2 through 4, it is to be understood that the invention is not limited to any specific logic equations. Rather, any logical function can be represented using such table-based methodologies of the present invention.

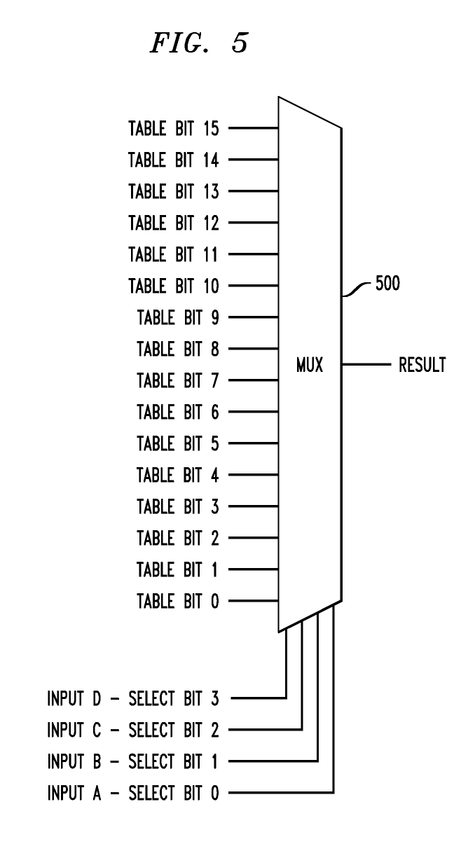

From a hardware standpoint, the single-instruction processing nature of the table-based methodologies previously described in conjunction with FIGS. 1 through 4 may be illustrated using a multiplexer, as shown in FIG. 5. With reference now to FIG. 5, an exemplary 16-to-1 multiplexer (MUX) 500 is depicted for performing methodologies of the present invention, according to an embodiment of the invention. More particularly, multiplexer 500 includes 16 data inputs, namely, Table Bit 0 through Table Bit 15 (i.e., Table Bit 0:15), each data input being adapted to receive a respective bit of illustrative table 100 shown in FIG. 1. Multiplexer 500 further includes four control inputs, labeled Select Bit 0 through Select Bit 3 (i.e., Select Bit 0:3), each control input being adapted to receive a respective one of the variables A through D used in determining the result of a given logical operation. An output of multiplexer 500 is operative to generate an output result (Result) as a function of a logical state of the control inputs and the data inputs supplied to the multiplexer.

For instance, given the table assignment 400 shown in FIG. 4A for determining the result of the logical equation (A and B) or (C and D), variable A is preferably supplied to control input Select Bit 0 of multiplexer 500, variable B is presented to Select Bit 1, variable C is presented to Select Bit 2, and variable D is presented to Select Bit 3. Additionally, the data inputs of multiplexer 500 as set to implement table 400 by presenting a logical “1” (e.g., high voltage level, which may be VDD) on Table Bits 3, 7, 11, 12, 13, 14 and 15, and presenting a logical “0” (e.g., low voltage level, which may be ground or zero) on Table Bits 0, 1, 2, 4, 5, 6, 8, 9 and 10. In this manner, the multiplexer 500 will output the particular bit value specified by the control inputs using variables A, B, C and D essentially as an address.

It is to be understood that a different multiplexer configuration may be used to implement a different logical operation having a different number of variables and/or table arrangement, as will become apparent to those skilled in the art given the teachings herein. For example, an 8-to-1 multiplexer having eight data inputs and three control inputs may be used to implement a table-based approach for performing a multiple-operand logical calculation in a single instruction including three variables (e.g., A, B, C) and eight combinations of bit assignments (e.g., table bits 0 through 7), according to other embodiments of the invention.

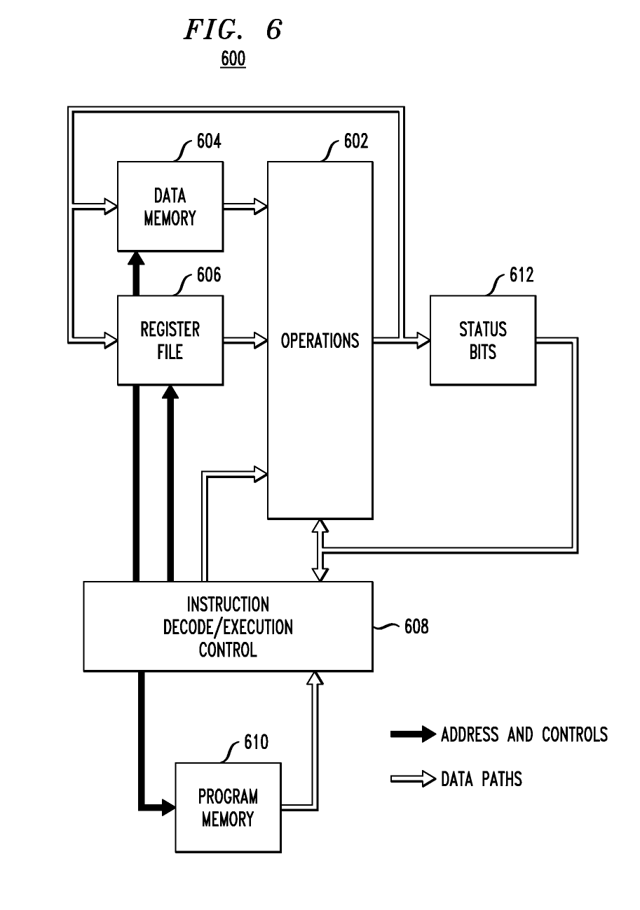

FIG. 6 is a block diagram depicting at least a portion of an exemplary processor 600 configured to implement methodologies of the present invention described herein, according to an embodiment of the invention. By way of example only and without loss of generality, processor 600 includes an operations bock 602 adapted to perform specified logical operations based at least in part on data, which may be stored in a data memory 604 and/or a register file 606 coupled to the operations block, and/or on control information, which may be stored in an instruction decode/execution control block 608 also coupled to the operations block. Operations block 602 may include, for example, an arithmetic logic unit (ALU), a central processing unit (CPU), and/or other logic or arithmetic circuitry. Program code for determining execution flow may be stored in program memory 610 coupled to instruction decode/execution control block 608.

Instructions loaded by the instruction decode/execution control block 608 from program memory 610 tell the operations block 602 which type of mathematical or logical calculations to perform and where to store results of such calculations. Results from the operations block 602 may be sent to a status bits register 612 and/or the results may be stored in data memory 604 and/or register file 606 for immediate or subsequent use. Results, or status bits indicative thereof, stored in status bits register 612 may be used by the instruction decode/execution control block 608 for controlling program execution. It is to be appreciated that two or more steps for performing a method according to techniques of the invention may be performed on different processors, which may be particularly useful in a distributed computing or parallel processing environment.

Most processors and computers typically support conditional execution commonly based on a status of previous operations. Some processors/computers even support multiple status and methods to combine such status. Generally, these combinations are from multiple status of the same operation; for example, “equal “0” may be one possible status and “negative” may be another. Combinations of status may support tests for “equal,” “greater than or equal to,” “less than or equal to,” etc. As previously stated, aspects of the invention beneficially provide an instruction that combines any number of “results” into a single test.

Although the processor 600 is shown as being comprised of discrete functional blocks, it is to be appreciated that one or more of these functional blocks may be combined, either together or with other functional blocks (not explicitly shown), to form one or more other functional blocks which incorporate the functions of the combined blocks. For example, data memory 604 and program memory 610 may reside in separate memory spaces of the same physical memory block.

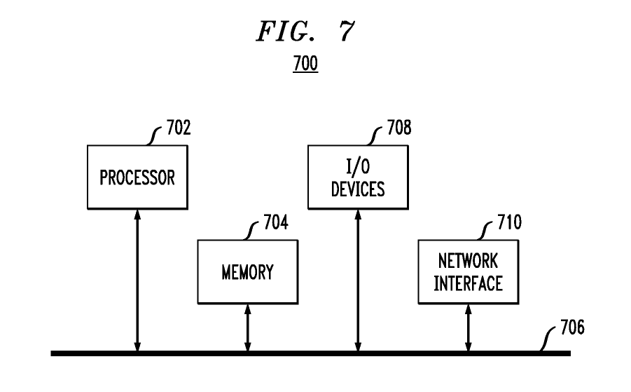

Methodologies of embodiments of the present invention may be particularly well-suited for implementation in an electronic device or alternative system, such as, for example, a microprocessor or other processing device/system. By way of illustration only, FIG. 7 is a block diagram depicting an exemplary data processing system 700, formed in accordance with an aspect of the invention. System 700 may represent, for example, a general purpose computer or other computing device or systems of computing devices. System 700 may include a processor 702, memory 704 coupled to the processor, as well as input/output (I/O) circuitry 708 operative to interface with the processor. The processor 702, memory 704, and I/O circuitry 708 can be interconnected, for example, via a bus 706, or alternative connection means, as part of data processing system 700. Suitable interconnections, for example via the bus, can also be provided to a network interface 710, such as a network interface card (NIC), which can be provided to interface with a computer or Internet Protocol (IP) network, and to a media interface, such as a diskette or CD-ROM drive, which can be provided to interface with media. The processor 702 may be configured to perform at least a portion of the methodologies of the present invention described herein above.

It is to be appreciated that the term “processor” as used herein is broadly intended to include any processing device, such as, for example, one that includes a central processing unit (CPU) and/or other processing circuitry (e.g., network processor, DSP, microprocessor, etc.). Additionally, it is to be understood that the term “processor” may refer to more than one processing device, and that various elements associated with a processing device may be shared by other processing devices. The term “memory” as used herein is broadly intended to include memory, or an alternative storage element, and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is broadly intended to include, for example, one or more input devices (e.g., keyboard, mouse, etc.) for entering data to the processor, one or more output devices (e.g., printer, monitor, etc.) for presenting the results associated with the processor, and/or interface circuitry for operatively coupling the input or output device(s) to the processor.

Accordingly, an application program, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 702. In any case, it is to be appreciated that at least a portion of the components shown in any of FIGS. 2 through 4 may be implemented in various forms of hardware, software, or combinations thereof, e.g., one or more DSPs with associated memory, application-specific integrated circuits (ASICs), functional circuitry, one or more operatively programmed general purpose digital computers with associated memory, etc. Given the teachings of the invention provided herein, one of ordinary skill in the art will be able to contemplate other implementations of the components of the invention.

At least a portion of the techniques of the present invention may be implemented in one or more integrated circuits (ICs). In forming integrated circuits, die are typically fabricated in a repeated pattern on a surface of a semiconductor wafer. Each of the die includes a memory described herein, and may include other structures or circuits. Individual die are cut or diced from the wafer, then packaged as integrated circuits. One skilled in the art would know how to dice wafers and package die to produce integrated circuits. Integrated circuits so manufactured are considered part of this invention.

An IC in accordance with embodiments of the present invention can be employed in any application and/or electronic system which is adapted for performing multiple-operand logical calculations in a single instruction. Suitable systems for implementing embodiments of the invention may include, but are not limited to, personal computers, portable computing devices (e.g., personal digital assistants (PDAs)), multimedia processing devices, etc. Systems incorporating such integrated circuits are considered part of this invention. Given the teachings of the invention provided herein, one of ordinary skill in the art will be able to contemplate other implementations and applications of the techniques of the invention.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method for performing multiple-operand logical operations in a single instruction, the method comprising the steps of:
generating a table defining a correspondence between a plurality of input variables to a multiple-operand logical operation and a plurality of output results of the multiple-operand logical operation;
encoding the table to generate a set of values for use by the single instruction, each value in the set of values being indicative of an output result of the multiple-operand logical operation as a function of a corresponding unique combination of values of the plurality of input variables to the multiple-operand logical operation; and
at least one processor performing the multiple-operand logical operation in a single instruction as a function of the set of values for a prescribed combination of values of the plurality of input variables.

2. The method of claim 1, wherein at least a portion of the table is encoded in at least one of the single instruction itself, an immediate field of the instruction and a storage element of the at least one processor implementing at least a portion of the method.

3. The method of claim 1, wherein the step of generating the table comprises:
determining a number, n, of input variables to the multiple-operand logical operation and a number, m, of possible logical values that each input variable represents, a number of bit positions in the table being equal to mⁿ, where m and n are integers greater than one; and
assigning logical values to the respective bit positions in the table, each logical value corresponding to a unique logical combination of the plurality of variables as a function of a prescribed value for each of the input variables.

4. The method of claim 3, wherein each of the input variables to the multiple-operand logical operation is a binary value.

5. The method of claim 1, wherein at least one of the input variables to the multiple-operand logical operation comprises at least one status bit generated as a result of at least one of a previous operation and a current operation performed by the at least one processor implementing at least a portion of the method.

6. The method of claim 5, wherein the at least one status bit is indicative of a result of a comparison between two or more input variables to the at least one of the previous operation and the current operation.

7. The method of claim 5, wherein the at least one status bit is indicative of at least one of a prescribed definition and a configurable definition of a logical result of one or more input variables to the at least one of the previous operation and the current operation.

8. The method of claim 1, wherein the step of generating the table comprises testing each of the combination of values of the plurality of input variables using a logical comparison to determine whether the corresponding bit position in the table satisfies the multiple-operand logical operation.

9. The method of claim 1, wherein a result of one or more logical calculations utilized by the multiple-operand logical operation is encoded into at least one of the input variables to the multiple-operand logical operation.

10. The method of claim 1, wherein each of the input variables to the multiple-operand logical operation comprises a result of one or more intermediate logical calculations utilized by the multiple-operand logical operation.

11. The method of claim 1, wherein at least one of the steps of generating the table and encoding the table are implemented by the at least one processor.

12. The method of claim 1, wherein at least two of the steps of generating the table, encoding the table and performing the multiple-operand logical operation are performed by different processors.

13. An apparatus for performing multiple-operand logical operations in a single instruction, the apparatus comprising:
memory; and
at least one processor coupled to the memory and operative: (i) to receive a table defining a correspondence between a plurality of input variables to a multiple-operand logical operation and a plurality of output results of the multiple-operand logical operation, the table being encoded so as to generate a set of values for use by the single instruction, each value in the set of values being indicative of an output result of the multiple-operand logical operation as a function of a corresponding unique combination of values of the plurality of input variables to the multiple-operand logical operation; and (ii) to perform the multiple-operand logical operation in a single instruction as a function of the set of values for a prescribed combination of values of the plurality of input variables.

14. The apparatus of claim 13, wherein at least a portion of the table is encoded in at least one of the single instruction itself, an immediate field of the instruction and the memory.

15. The apparatus of claim 13, wherein the at least one processor is further operative: to determine a number, n, of input variables to the multiple-operand logical operation and a number, m, of possible logical values that each input variable represents, a number of bit positions in the table being equal to mⁿ, where m and n are integers greater than one; and to assign logical values to the respective bit positions in the table, each logical value corresponding to a unique logical combination of the plurality of variables as a function of a prescribed value for each of the input variables.

16. The apparatus of claim 15, wherein each of the input variables to the multiple-operand logical operation is a binary value.

17. The apparatus of claim 13, wherein at least one of the input variables to the multiple-operand logical operation comprises at least one status bit generated as a result of at least one of a previous operation and a current operation performed by the at least one processor, at least one of the input variables to the multiple-operand logical operation comprising the at least one status bit.

18. The apparatus of claim 17, wherein the at least one status bit is indicative of a result of a comparison between two or more input variables to the at least one of the previous operation and the current operation performed by the at least one processor.

19. The apparatus of claim 17, wherein the at least one status bit is indicative of at least one of a prescribed definition and a configurable definition of a logical result of one or more input variables to the at least one of the previous operation and the current operation performed by the at least one processor.

20. The apparatus of claim 13, wherein the at least one processor is further operative to test each of the combination of values of the plurality of input variables using a logical comparison to determine whether the corresponding bit position in the table satisfies the multiple-operand logical operation.

21. The apparatus of claim 13, wherein a result of one or more logical calculations utilized by the multiple-operand logical operation is encoded into at least one of the input variables to the multiple-operand logical operation.

22. The apparatus of claim 13, wherein each of the input variables to the multiple-operand logical operation comprises a result of one or more intermediate logical calculations performed by the at least one processor and utilized by the multiple-operand logical operation.

23. The apparatus of claim 13, wherein the at least one processor is further operative to perform at least one of generating the table and encoding the table.

24. An electronic system including at least one integrated circuit adapted to perform multiple-operand logical operations in a single instruction, the at least one integrated circuit comprising:
embedded memory; and
at least one processor coupled to the embedded memory and operative: (i) to receive a table defining a correspondence between a plurality of input variables to a multiple-operand logical operation and a plurality of output results of the multiple-operand logical operation, the table being encoded so as to generate a set of values for use by the single instruction, each value in the set of values being indicative of an output result of the multiple-operand logical operation as a function of a corresponding unique combination of values of the plurality of input variables to the multiple-operand logical operation; and (ii) to perform the multiple-operand logical operation in a single instruction as a function of the set of values for a prescribed combination of values of the plurality of input variables.
